(19) United States
(12) Patent Application Publication
(10) Pub. No.: US 2025/0080657 A1
(43) Pub. Date: Mar. 6, 2025

(54) METHOD OF DETERRING UNSOLICITED TELEPHONE CALLS

(71) Applicant: Hamid Ayub, Plantation, FL (US)

(72) Inventors: Hamid Ayub, Plantation, FL (US); Alina N. Ayub, Plantation, FL (US); Kashif O. Ayub, Plantation, FL (US)

(21) Appl. No.: 18/241,877

(22) Filed: Sep. 3, 2023

(51) Int. Cl. H04M 15/00; H04M 3/42; H04M 3/436

(52) U.S. Cl. CPC H04M 15/47; H04M 3/42059; H04M 3/436

(57) ABSTRACT

The present disclosure relates in general to tools and techniques for deterring or blocking unsolicited telephone calls which includes searching and determining that the originating telephone number is in phone directory/phone book/contact list of the called party, and based on this determination, connecting the calling party to the called party if the originating telephone number is present in the phone directory/phone book/contact list. The method further comprises disconnecting the call, in case the calling party cannot be charged. The calling party may optionally be informed through a text message that their call could not be connected without payment of charges as the call to the called party is chargeable.

### FIELD OF THE INVENTION

The present disclosure relates in general to tools and techniques for deterring or discourage unsolicited telephone calls, particularly to methods and apparatus for managing fraudulent calls by charging the calling party by the user.

### BACKGROUND OF THE INVENTION

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

With development of telephone communications, the number of parties offering services via telephone has increased. Telephone calls from these parties, such as telemarketers, pollsters, and charitable organizations, sometimes referred to as spam calls, robocalls, or junk calls, are typically unsolicited, placed in bulk and made indiscriminately. Telemarketers employ increasingly sophisticated technology to get their calls through to their target audience despite people's desire to be left alone. Furthermore, telemarketers can employ computers to dial a number until the call is answered, so they can automatically transfer the call to a human agent. This can be heard as a pause after the phone call is answered but before the called party can speak to the human agent.

In some cases, autodialers or robocallers might be used to initiate such unsolicited calls (which might include voice calls or text messages, or both) in an automated manner (either sequentially and/or in a random fashion).

For any person, receiving an unsolicited call can be an annoyance and a frustration, especially if the recipient of the unsolicited call had previously indicated to the caller that he or she does not wish to receive future calls from the caller and/or if the recipient had previously put the telephone number of the unsolicited caller on a no-call list.

Existing methods for protecting the consumers against such unsolicited calls include call screening, anonymous call blocking, and caller compliance with a national “Do Not Call” list. Consumers can employ a variety of defences against undesired callers. Some telephone services can allow anonymous call reject so that the phone does not ring if the caller Identification (ID) is blocked.

Some privacy protection techniques can employ a “whitelist” of known acceptable callers and a “blacklist” of known undesired callers, but blocking only blacklisted numbers often lets too many “junk” calls through due to the blacklist being incomplete, while allowing only calls from whitelisted numbers may be too restrictive. Moreover, managing blacklists and whitelists manually can be bothersome and often can be cumbersome.

However, such methods may not deter persistent unsolicited callers. Such callers may simply ignore Do Not Call lists, use a bank of phones having different telephone numbers from which to make unsolicited calls, employ non-anonymous caller ID names, and/or target other average people, who might not utilize any of these protective methods.

The embodiments disclosed herein are directed toward overcoming one or more of the problems discussed above.

### SUMMARY OF THE INVENTION

Various embodiments provide techniques to deter or discourage and/or penalize unsolicited telephone calls. In some embodiments, deterring unsolicited telephone calls includes searching and determining that the originating telephone number is in phone directory/phone book/contact list of the called party, and based on this determination, connecting the calling party to the called party if the originating telephone number is present in the phone directory/phone book/contact list.

In an aspect of some embodiments, if, the originating telephone number is not present in phone directory/phone book/contact list, checking that the calling party can be charged or not. The method further comprises disconnecting the call, in case the calling party cannot be charged. The calling party may optionally be informed through a text message that their call could not be connected without payment of charges as the call to the called party is chargeable.

In an aspect of some embodiments, if the calling party can be charged, informing the calling party that the called party phone is a back charge phone and calling party is being charged. Based on the information received by the calling party about the back charge, the calling party may accept to pay the charges and subsequently call is connected to the called party phone. In case, if the calling party does not accept to pay the back charge the call is disconnected. Alternatively, the calling party may on their own, disconnect the call if they do not want to pay the charges.

According to some embodiments, if the spammer is calling from a legitimate phone, once diverted to pay-per-call, the calling party is put on hold to announce that the call can be charged and/or text informing the calling party.

According to some embodiments, the called party may waive the charges incurred to the calling party after having conversation.

According to some embodiments, the call information is provided to a charge back system. The charge back system requests confirmation of charge from the called party whether the calling party required to be charged or the charges should be waived. On receiving the response from the called party the charge back system charges the calling party or waive the charges accordingly.

According to some embodiments, deterring unsolicited telephone calls includes imposing penalties for no-call violators (e.g., solicitors).

In accordance with some embodiments, the caller or solicitor might be billed or charged with the unsolicited calls based at least in part on the information gathered in the called party phone and the statistics of no-call list violations. In some embodiments, the called party (e.g., recipients or subscribers who are actually connected with the solicitor) may be credited, in part or in full, using any payments provided by the caller to the service provider in order to satisfy or pay the bills.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In some cases, the method might further comprise associating, in a database, the calling party, as a single calling entity, with a plurality of telephone numbers that originate unsolicited telephone calls. The method might further comprise prohibiting termination of one or more telephone calls from one or more telephone numbers associated with the calling party, the one or more telephone numbers comprising the plurality of telephone numbers that originate unsolicited telephone calls and at least one other telephone number.

According to some embodiments, the method might also comprise adding, with the computer system, information about the calling party to the database comprises adding the originating telephone number to the database.

In some cases, the method might further comprise playing, through the telephone switch, an audible warning to the originating telephone number on the call, the audible warning indicating that the calling party may be charged for connecting the call.

In some embodiments, the method might further comprise determining by called party, that the calling party associated with the originating telephone number has been warned previously about unsolicited telephone calls and imposing a penalty on the calling party in addition to back charges in response to determining that the calling party has been warned previously and continues to originate unsolicited telephone calls.

In some embodiments, the method might comprise maintaining the database of telephone numbers that originate unsolicited telephone calls, receiving, at the telephone switch, the first call originating from the calling party number and directed to the destination telephone number, terminating the first call to the destination telephone number, and receiving, at the telephone switch, user input from the user at the destination telephone number.

In another aspect, an apparatus might comprise a non-transitory computer readable medium having encoded thereon a set of instructions executable by one or more computers to cause the one or more computers to perform the method described hereinabove.

According to some embodiments, the set of instructions, executable by the one or more computers, might further cause the apparatus to search and determine that the originating telephone number is in phone directory/phone book/contact list of the called party, and based on this determination, connect the calling party to the called party if the originating telephone number is present in the phone directory/phone book/contact list. If the originating telephone number is not present in phone directory/phone book/contact list, the set of instructions, executable by the one or more computers, might further cause the apparatus to check that the calling party can be charged or not and disconnect the call, in case the calling party cannot be charged. The calling party may optionally be informed by the apparatus through a text message that their call could not be connected without payment of charges as the call to the called party is chargeable.

According to some embodiments, a computer system might comprise one or more processors and a computer readable medium in communication with the one or more processors. The computer readable medium might have encoded thereon a set of instructions executable by the computer system to search and determine that the originating telephone number is in phone directory/phone book/contact list of the called party, and based on this determination, connect the calling party to the called party if the originating telephone number is present in the phone directory/phone book/contact list. If the originating telephone number is not present in phone directory/phone book/contact list, the set of instructions, executable by the one or more computers, might further cause the apparatus to check that the calling party can be charged or not and disconnect the call, in case the calling party cannot be charged. The calling party may optionally be informed by the apparatus through a text message that their call could not be connected without payment of charges as the call to the called party is chargeable.

Various modifications and additions can be made to the embodiments discussed without departing from the scope of the invention. For example, while the embodiments described above refer to particular features, the scope of this invention also included embodiments having different combination of features and embodiments that do not include all of the above described features.

### BRIEF DESCRIPTION OF THE DRAWINGS

The disclosed aspects will hereinafter be described in conjunction with the appended drawings, provided to illustrate and not to limit the disclosed aspects, wherein like designations denote the elements.

FIG. 1 shows a flow diagram illustrating various methods for deterring or discourage and/or penalize unsolicited callers, in accordance with various embodiments.

FIG. 2 shows a flow diagram illustrating various methods for charge-back system, in accordance with various embodiments.

FIG. 3 is an example of an apparatus which may also be used with one embodiment.

### DETAILED DESCRIPTION

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As is well understood in the art, the term, “termination of a call” or similar phrasing (e.g., “terminating a call,” “disconnecting a call” etc.), means preventing the connection of a call between a caller and a recipient and/or refusing to connect the call (e.g., by the telephone switch rejecting the call). Conversely, “connecting a call” or similar phrasing (e.g., “prohibiting termination of a call”, “preventing a call from terminating,” etc.) means connecting a call between a caller and a recipient. Hereinafter, unless otherwise specified, “no-call list” refers to either a personal no-call list, a regional no-call list, a national no-call list, and/or a global/international no-call list. Hereinafter, unless otherwise indicated, the “subscriber” refers to the intended recipient of the call originated by the originating telephone (which, e.g., may be associated with the “caller”). In other words, the subscriber is a person who is associated with the destination telephone number and/or the destination telephone(s); either the person and/or the destination telephone number may be associated with the service provider.

In addition, for the purposes of this document, the terms, “calling party” “originating telephone” and “originating telephone number” (which is associated with the “originating telephone”) should be considered interchangeable unless the context dictates otherwise. Likewise, the terms “called party”, “destination telephone” and “destination telephone number” (which is associated with the “destination telephone”) can be considered interchangeable unless the context dictates otherwise. Hereinafter, the terms, “no-call list” and “no-call-list database,” can refer either to the contents of a no-call list (e.g., originating numbers and/or correlated subscriber numbers) or to a database in which the list is stored, depending on context. The terms “deterring, “blocking” “discouraging”, “penalizing” used interchangeably throughout the specification and are meant to keep check on unsolicited calls. The term “unsolicited call” includes the terms “undesirable calls” such as “promotional calls”, “junk calls” or spam calls”.

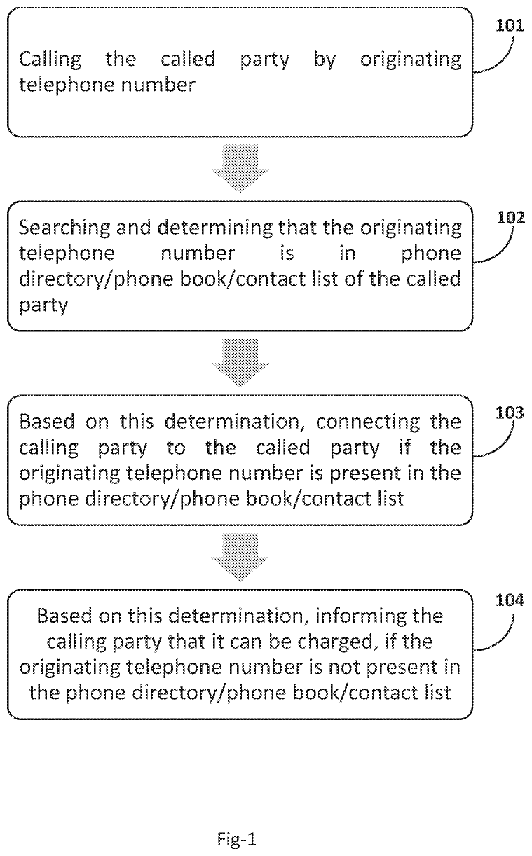

FIG. 1 shows an example of a method which can be implemented by a mobile device. The process 100 starts at 101, when the calling party placed as call to the called party, which may include unsolicited telephone calls. At 102 the method includes searching the phone directory/phone book/contact list and determining that the originating telephone number is present in phone directory/phone book/contact list of the called party. Based on this determination if the originating telephone number is present in the phone directory/phone book/contact list the calling party is connected to the called party and phone rings. Subsequently, the called party may pick up the phone and have conversation.

In the next step, if, the originating telephone number is not present in phone directory/phone book/contact list, checking that the calling party can be charged or not at step 103. If there is no way by which the calling party can be charged, call is disconnected at step 104. The calling party may optionally be informed through a text message that their call could not be connected without payment of charges as the call to the called party is chargeable by a text message or a voice message.

Therefore, the unsolicited telephone callers are deterred or blocked if they cannot be charged for such calls.

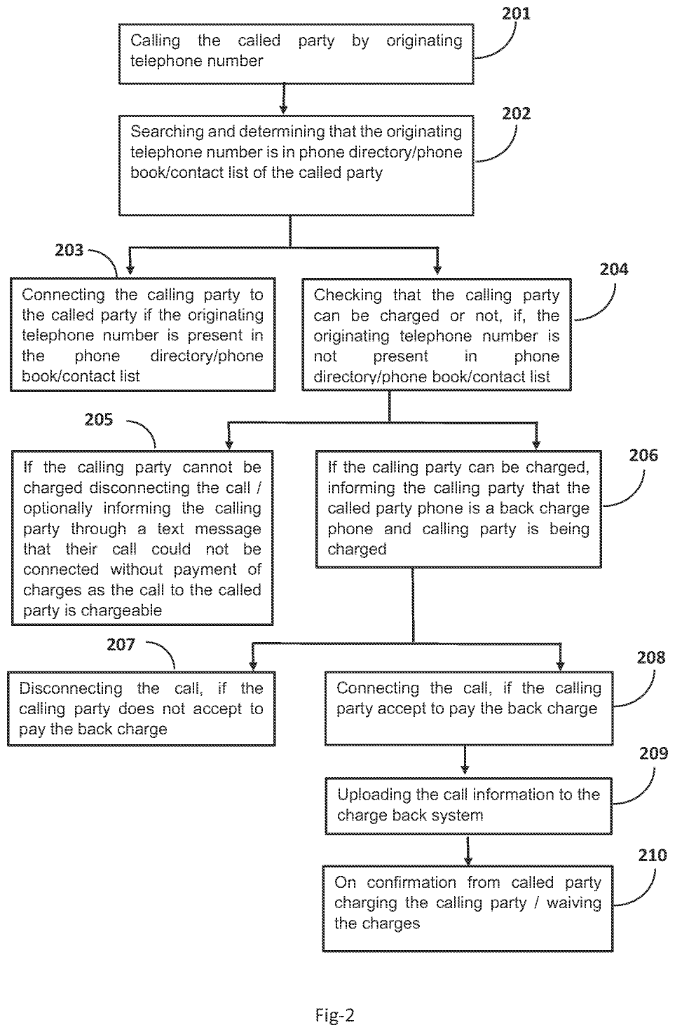

FIG. 2 shows an example of a method which can be implemented by a mobile device. Steps 201 to 203 are likewise steps 101 to 103 described above with reference to FIG. 1.

At step 204 on receiving a call the called party checks if the originating number is not present in the contact list of the called party and whether the calling party can be charged.

At step 205, if the calling party cannot be charged the call is disconnected. Optionally the calling party is informed through a text message that their call could not be connected without payment of charges as the call to the called party is chargeable.

If the calling party can be charged, at step 206, the calling party is informed that the called party phone is a back charge phone and calling party may be charged. According to some embodiments, if the spammer is calling from a legitimate phone, once diverted to pay-per-call, the calling party is put on hold to announce that the call can be charged and/or text informing the calling party.

Based on the information received by the calling party about the back charge, if the calling party does not accept to pay the back charge the call is disconnected at step 207. Alternatively, the calling party may on their own, disconnect the call if they do not want to pay the charges.

The calling party may accept to pay the charges and subsequently call is connected to the called party phone at step 208.

According to some embodiments, the call information is provided to a charge back system at step 209. The charge back system requests confirmation of charge from the called party whether the calling party required to be charged or the charges should be waived. On receiving the response from the called party the charge back system charges the calling party or waive the charges accordingly.

According to some embodiments, deterring unsolicited telephone calls includes imposing penalties for no-call violators (e.g., solicitors).

In accordance with some embodiments, the caller or solicitor might be billed or charged with the unsolicited calls based at least in part on the information gathered in the called party phone and the statistics of no-call list violations. In some embodiments, the called party (e.g., recipients or subscribers who relate to the solicitor) may be credited, in part or in full, using any payments provided by the caller to the service provider in order to satisfy or pay the bills.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In some cases, the method might further comprise associating, in a database, the calling party, as a single calling entity, with a plurality of telephone numbers that originate unsolicited telephone calls. The method might further comprise prohibiting termination of one or more telephone calls from one or more telephone numbers associated with the calling party, the one or more telephone numbers comprising the plurality of telephone numbers that originate unsolicited telephone calls and at least one other telephone number.

According to some embodiments, the method might also comprise adding, with the computer system, information about the calling party to the database comprises adding the originating telephone number to the database.

In some cases, the method might further comprise playing, through the telephone switch, an audible warning to the originating telephone number on the call, the audible warning indicating that the calling party may be charged for connecting the call.

In some embodiments, the method might further comprise determining by called party, that the calling party associated with the originating telephone number has been warned previously about unsolicited telephone calls and imposing a penalty on the calling party in addition to back charges in response to determining that the calling party has been warned previously and continues to originate unsolicited telephone calls.

In some embodiments, the method might comprise maintaining the database of telephone numbers that originate unsolicited telephone calls, receiving, at the telephone switch, the first call originating from the calling party number and directed to the destination telephone number, terminating the first call to the destination telephone number, and receiving, at the telephone switch, user input from the user at the destination telephone number.

It will be appreciated that FIGS. 1 and 2 show examples of possible methods and that alternative methods, in alternative embodiments, can use fewer operations or more operations or can use operations in a different sequence than shown.

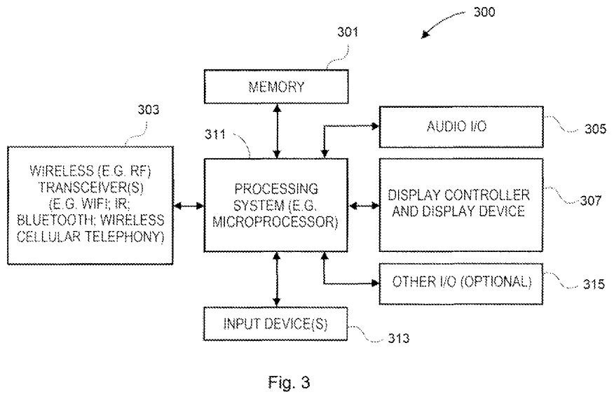

FIG. 3 shows an example of an apparatus which may be used with one or more embodiments described herein. The apparatus 300 shown in FIG. 3 includes a processing system 311, which may be one or more microprocessors, or which may be a system on a chip (integrated circuit), and the system also includes memory 301 for storing data and programs for execution by the processing system. Memory 301 can be one or more forms of machine readable non-transitory storage media for storing computer program instructions which when executed by apparatus 300 cause apparatus 300 to perform the one or more methods described herein. For example, memory 301 can be DRAM or Flash memory or other forms of volatile or non-volatile semiconductor memory or other forms of memory. The apparatus 300 also includes audio input/output subsystem 305 which may include a microphone and a speaker for, for example, playing back music or providing telephone functionality through the speaker and microphone.

A display controller and display device 307 provide a visual user interface for the user; this digital interface may include a graphical user interface which is similar to that shown on a typical operating system software. The system 300 also includes one or more wireless transceivers 303. A wireless transceiver may be a WiFi transceiver, an infrared transceiver, a Bluetooth transceiver, and/or a wireless cellular telephony transceiver or a combination of a set of such transceivers. It will be appreciated that additional components, not shown, may also be part of the apparatus 300 in certain embodiments, and in certain embodiments fewer components than shown in FIG. 3 may also be used in a data processing system.

The apparatus 300 also includes one or more input devices 313 which are provided to allow a user to provide input to the system. These input devices may be a keypad or a keyboard or a touch panel or a multi touch input panel. The apparatus 300 also includes an optional input/output device 315 which may be a connector for a dock. It will be appreciated that one or more buses, not shown, may be used to interconnect the various components as is well known in the art. The apparatus shown in FIG. 3 may be a handheld computer, or a tablet computer such as an iPad or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device. In other embodiments, the apparatus 300 may be a network computer or an embedded processing device within another device, or a consumer electronic device or other types of data processing systems which have fewer components or perhaps more components than that shown in FIG. 3.

In the foregoing specification, specific exemplary embodiments have been described. It will be evident that various modifications may be made thereto without departing from the broader spirit and scope as set forth in the following claims. The specification and drawings are, accordingly, to be regarded in an illustrative sense rather than a restrictive sense.

1. A method of deterring unsolicited telephone calls, the method comprising:
on receiving a call, searching and determining that an originating telephone number is in a contact list of a called party,
checking that a calling party be charged or not, if the originating telephone number is not present in the contact list;
in response to determination that calling party can be charged, informing the calling party that a called party phone is a back charge phone, and the calling party is being charged;
accepting by the calling party to pay charges based on information received by the calling party about a back charge;
connecting the call to the called party phone and providing a call information to a charge back system;
requesting by the charge back system, a confirmation of charge from the called party comprising whether the calling party is required to be charged, after a call is connected to the called party;
receiving a response from the called party comprising a confirmation of charge to the calling party; and
charging the calling party by the charge back system;
wherein the method further comprising:
requesting by the charge back system for confirmation of a waiver of the charge from the called party, after a call is connected to the called party;
in response to the conversation between the called party and calling party, receiving the response from the called party regarding the confirmation of the waiver of charge to the calling party;
waiving the charges incurred to the calling party after having the conversation on the call.

2. The method as claimed in claim 1, further comprising:
disconnecting the call, in case the calling party cannot be charged; and
informing the calling party through a text message that the call is not connected.

3. The method as claimed in claim 1, wherein:
calling party is put on hold to inform the call is being charged or text informing the calling party about the charge.

4. (canceled)

5. A machine readable non-transitory storage medium containing executable instructions which when executed by a data processing system cause the system to perform a method comprising:
on receiving a call, searching and determining that an originating telephone number is in a contact list of a called party,
checking that a calling party be charged or not if the originating telephone number is not present in the contact list;
in response to determination that calling party can be charged, informing the calling party that a called party phone is a back charge phone, and the calling party is being charged;
accepting by the calling party to pay charges based on an information received by the calling party about a back charge;
connecting the call to the called party phone and providing a call information to a charge back system;
requesting by the charge back system, a confirmation of a charge from the called party comprising whether the calling party is required to be charged, after a call is connected to the called party;
receiving a response from the called party comprising a confirmation of charges to the calling party; and
charging the calling party by the charge back system
wherein the method further comprising:
requesting by the charge back system for confirmation of a waiver of charge from the called party, after a call is connected to the called party;
in response to the conversation between the called party and calling party, receiving the response from the called party regarding the confirmation of the waiver of charge to the calling party;
waiving the charges incurred to the calling party after having the conversation on the call.

6. The medium as claimed in claim 5, the method further comprising:
disconnecting the call, in case the calling party cannot be charged; and
informing the calling party through a text message that the call is not connected.

7. The medium as claimed in claim 5, wherein:
calling party is put on hold to inform the call is being charged and/or text informing the calling party about the charge.

8. (canceled)

9. A computer program being executable by a processor to perform a method for filtering a phone call according to claim 1.

10. An apparatus deterring unsolicited telephone calls, the apparatus comprising:
a processor along with a memory unit configured to perform the method of claim 1.
